(19) United States
(12) Patent Application Publication
(10) Pub. No.: US 2010/0049336 A1
(43) Pub. Date: Feb. 25, 2010

(54) AUTOMATION SYSTEM COMPRISING AN IMPLEMENTED ENGINEERING-ENVIRONMENT

(75) Inventors: Armando Walter Colombo, Karlstein (DE); Axel Bepperling, Frankfurt (DE); Daniel Cachapa, Azeitao (PT); Rui Milagaia, Lisbon (PT)

Correspondence Address: DENNISON, SCHULTZ & MACDONALD, 1727 KING STREET, SUITE 105, ALEXANDRIA, VA, 22314, US

(73) Assignee: SCHNEIDER ELECTRIC AUTOMATION GmbH, Seligenstadt (DE)

(21) Appl. No.: 12/524,376

(22) PCT Filed: Jan. 25, 2008
(86) PCT No.: PCT/EP08/50885

§ 371 Date: Oct. 14, 2009

(30) Foreign Application Priority Data
Jan. 25, 2007 (DE) 10 2007 004 655.5

(51) Int. Cl. G05B 19/418

(52) U.S. Cl. 700/9; 700/20; 700/19

(57) ABSTRACT

An automation system including a service-oriented architecture and decentralized, distributed components and/or devices in a flexible and reconfigurable production environment. The system includes at least one host computer which is connected to service-oriented components and/or devices by means of a data transmission system such as Ethernet. In order to establish service-oriented systems of devices/components, the execution thereof in a virtual network and the synchronization thereof with real, physically existing components is provided such that the at least one host computer includes a virtual simulation-based engineering-environment including a virtual service-oriented communication platform for exchanging messages and interactions based on web services between virtual models of components and/or devices, in which the functionality thereof is available in the form of services.

The invention relates to an automation system with service-oriented architecture and decentralized, distributed components and/or devices in a flexible and reconfigurable production environment, with at least one host computer, which is connected by a data transmission means such as Ethernet to the service-oriented components and/or devices, as well as an engineering tool or system for, in particular, the integrated support of the life cycle of service-oriented architectures of decentralized, distributed components and/or devices in a flexible and reconfigurable production environment.

In the recent past and up until today, prevailing centralized/hierarchical control has run with earlier monolithic programming technology, i.e. the complete control logic, running on a few calculation-intensive SPS devices, which usually cyclically exchanges field busses and process data with sensors and actuators.

Nowadays, different trends are being observed:
Increasing computer performance and Ethernet are becoming more and more available on very small devices as well
Service-oriented architecture (SOA) based, for instance, on web-service technology, is making a first-time entrance into the automation world and is already being used as a communication and control platform.
Nowadays, the life cycle of a production system is being viewed in an integrated way and is being considered in planning.
Tools already exist for the development of services, for linking service components, and for modeling and developing applications and process flow.
Simulation and emulation tools are available for control-logic units (but not for distributed applications logic).

Starting from this point, the task of the invention is based on the further development of a system of the type mentioned in passing at the beginning, such that the construction of service-oriented systems of devices allows its performance in a virtual network and its synchronization with real, physically existing components.

The problem is thereby resolved according to the invention, among other things, such that a virtual simulation-based engineering environment with a virtual service-oriented communication platform is implemented in at least one host computer to for replacement by communications and interaction based on web services between virtual models of components and/or real components.

Preferably, the virtual components implemented in the host computer as service entities are addressable and autonomous in the virtual net.

A preferred embodiment is thus distinguished by the fact that the virtual service entities are discoverable and addressable from outside the virtual net and that this is achieved by assigning a physical endpoint address.

A further preferred embodiment is distinguished by the fact that the virtual service-oriented communication platform is achieved through the standard network and process function of the operating system of the host computer.

Preferably, the service-based components are implemented on the same host computer in separate processes or threads and are available through their own endpoint addresses.

Preferably, the communication between host-internal services as well as between host-internal services and external services of a component is transparently feasible.

Both real and virtual components are preferably described through a mechatronic module, a control module, and a communication module, in which the mechatronic module images visual and physical properties of machine and electronic parts, the control module images the control logic of the components, and the communication module is achieved in the form of a web service.

Furthermore, it is provided that real and virtual components exhibit the same communication platform (protocol stack).

A particular embodiment is hereby distinguished by the fact that service-oriented systems of components are exportable to the virtual simulation-based engineering platform.

An object of this invention is, furthermore, a modular, virtual engineering tool or system for, in particular, the integrated support of the life cycle of service-oriented architectures of decentralized, distributed components and/or devices in flexible and reconfigurable production environments with the aid of an integrated, simulation-based engineering platform. The component functionality is available as a service for other components in a network, based on web-service technology.

What is more, a mechatronic element of the automation and process-automation technology is called a “component”, which consists of a mechanical sensor part, which makes up a control functionality and has the capability of communication. In principle, it is in a position to execute its basic functions independently. Through communication and integrated control, the functionality can be released as a web service for other cross-linked components. All phases of a component and of the production system that can be run are called “life cycle.” These include, for instance, development, programming, compilation, start-up, monitoring, run-time diagnostics, simulation, reconfiguration, re-use, and much more.

In this way, the 2D/3D simulation-based design of component architectures is possible. In one characteristic according to the invention, the engineering environment allows the construction of service-oriented systems of devices, its execution in a virtual network, and its synchronization with real, physically existing components in order to allow for supervision, for instance.

Further details, advantages, and characteristics of the invention are submitted not only in the claims, the characteristics being understood from the latter, in and of themselves and/or in combination, but also from the following description of a preferred embodiment.

The figures shown are:

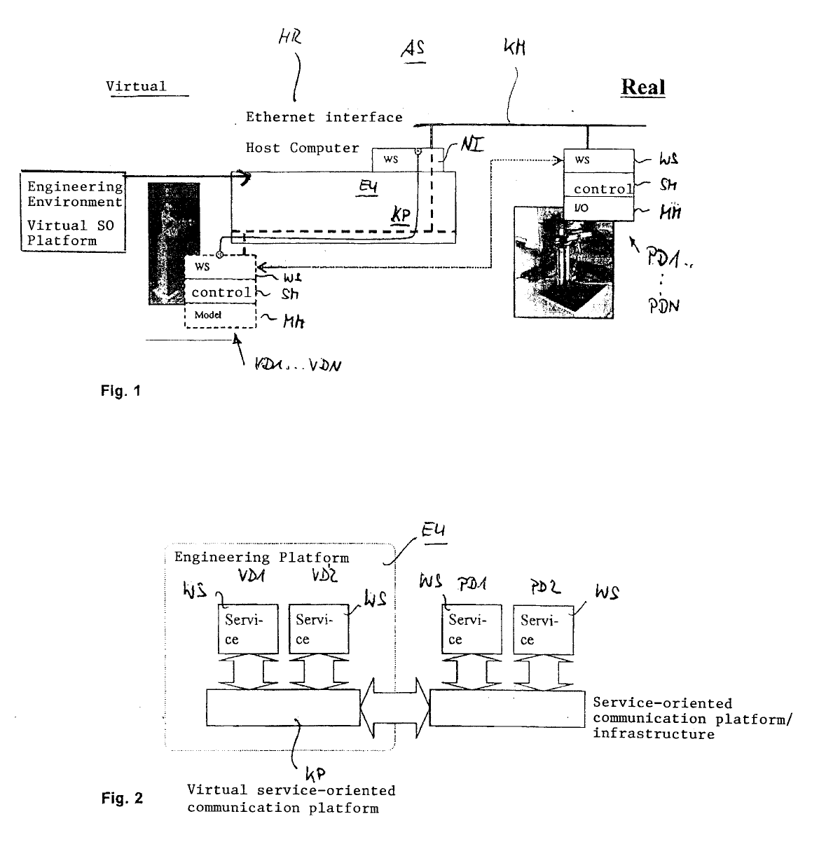

FIG. 1 a system architecture of an automation system including a host computer with implemented engineering environment and virtual service-oriented (SO) communication platform, which is connected by Ethernet to real components,

FIG. 2 a structure of the engineering platform,

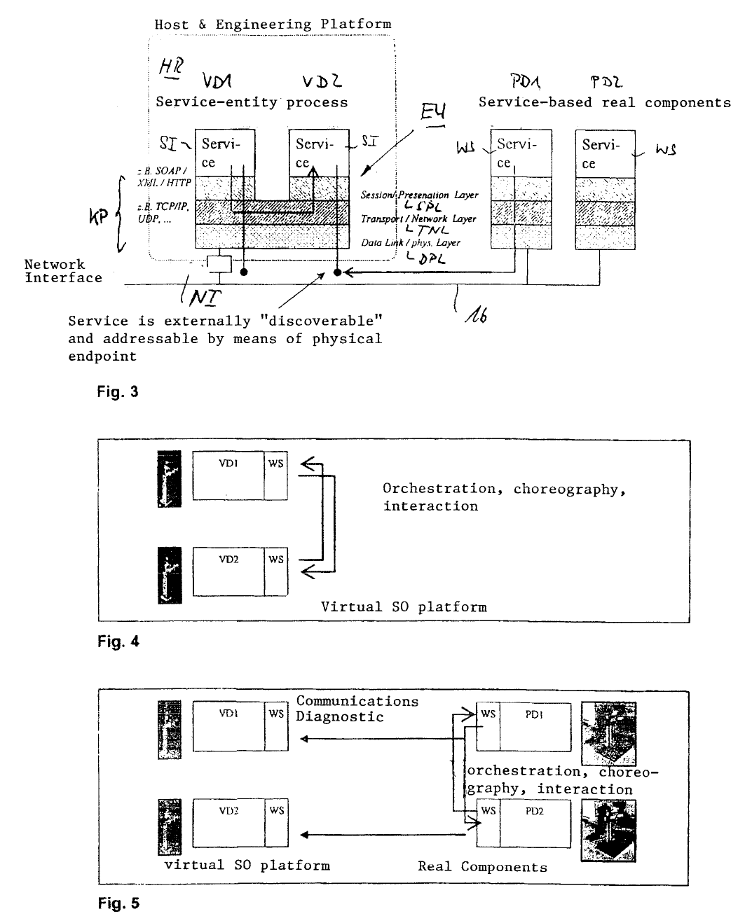

FIG. 3 a structure of a virtual service-oriented communication platform in an automation system according to FIG. 1,

FIG. 4 a “simulation and analysis” application example integrated into a single environment or in a physically separate environment (computer),

FIG. 5 a “run-time diagnostic” application example integrated into a single environment or in a physically separate environment, and

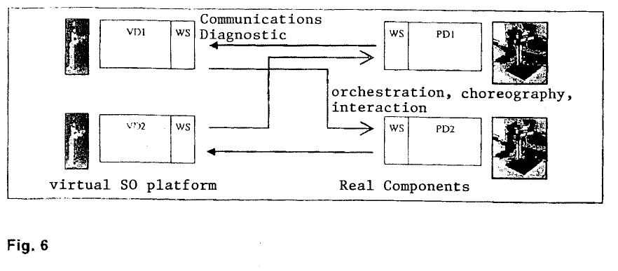

FIG. 6 a “test and supervision” application example integrated into a single environment or in a physically separate environment.

FIG. 1 shows a system architecture of an automation system AS, which is built into service-oriented architecture. The automation system AS includes at least one host computer HR, as well as distributed components and/or devices PD1 . . . PDN in a flexible and reconfigurable production environment, which are connected to one another by a communication means KM, such as Ethernet, and to the host computer HR. In the host computer HR, an engineering environment EU is implemented which provides an integrated, virtual, service-oriented communication platform.

Furthermore, virtual components VD1 . . . VDN are implemented, which exchanges communications and interactions with the virtual, service-oriented communication platform KP.

The virtual components VD1 . . . VDN exhibit essentially the same construction as the real components PD1 . . . PDN. The nature of the virtual and real components VD, PD is considered to be a unit made up of the following modules.

Mechatronic Module MM

A component VD, PD consists of machine, mechanical, and electronic parts, whose visible and physical properties are adequately depicted virtually (graphic model, movable parts). Proceeding from the granularity of the system, a component VD, PD may be, for example, an actuator, a machine, or an asset component.

Control Module SM

The components VD, PD possess the necessary computation resources (capacities) to independently achieve the functionality and may have different granularities (for example, sensor/actuator→machine→machine+intelligent control=physical agent). This means that the engineering tool EU can be used for small mechatronic components VD, PD as well as for aggregated components or complex mechatronic structures. For the application logic, non-essential mechanisms, such as moving machine parts, must be depicted by a separate logic, which, for example, simulate in the virtual model the time or collision behavior of the real components.

Communication Module WS

The device functionality under control is made available exclusively through service interfaces for other network nodes as a so-called service WS. As infrastructure, web-service technology is based on a simple-access application protocol (SOAP). The use of a device function in a higher context must therefore take place through the service interfaces. There are, at present, different approaches for establishing/coordinating a production process with services, for example a business-process engine with central coordination, or distributed, event-based coordination. These types of coordination are well-known from orchestration and choreography. These approaches can also be used in the area of intelligent-agent systems for control and communication.

A goal of the engineering tool EU is to deliver the integrated, virtual, service-oriented communication platform KP, which is made possible by the modeling of the components VD, PD (including 2D/3D modeling, service modeling, control development), as well as their simulation and maintenance in the virtual EU, KP environment.

“Engineering environment EU” is a general term for a set of tools which allows the graphic modeling of components and aggregates VD, PD, as well as the development of control logic. The programming code is developed offline, emulated, and loaded and executed in compiled form on the final platform.

The structure represented in FIG. 2 of a simulation-based engineering platform KP extends the engineering environment EU with simulation functionality, which allows the simulation of the system modeled in a pure virtual or heterogeneous production environment with real hardware.

The device and component functions are encapsulated as services WS, so that a further abstraction layer or infrastructure in the form, represented in FIG. 3, of a session/presentation layer SPL, a transport/network layer TNL, and a datalink/physical layer DPL is necessary, which makes the exchange of communications and interactions possible on the basis of web services, also called a service-oriented communication platform KP. The virtual service-oriented communication platform KP is thus characterized by the fact that no physical network for achieving a system of services is necessary, even if all the functions of the real platform are available. The service entities are addressable as distinct service endpoints in the virtual network (transport addresses) and act autonomously, i.e. unaffected by the coexistence of other systems. In addition, the virtual service entities SI must also be discoverable and addressable outside the virtual net.

The virtual, service-oriented communication platform KP may even require the standard network and process functions of the host operating system, if, for example, the service-based components VD1, VD2 are started up on the same host computer HR in separate processes (threads) and are available with their own endpoint addresses, as depicted in FIG. 3. Communication between services appears transparent, whether between host-internal services or between a host-internal service and an external service of a component.

By providing the integrated, virtual communication platform KP in the tool (engineering environment) EU, the following is achieved that the virtual components VD1 . . . VDN can communicate with precisely the same mechanisms as the real components PD1 . . . PDN.

The difference is minimal, whether it is a service in a real or a virtual environment, if both environments offer a communication platform (protocol stack) which has the same interfaces and refers to optimization for the respective run-time environment. Ideally, one and the same service component can, without any change, run and communicate in either a real component or in a container in a virtual environment.

The engineering environment EU offers the capability of both imaging and developing real components PD1 . . . PDN and virtual components VD1 . . . VDN with the abovementioned properties of mechatronics, control, and communication.

The aspect of reusability of components VD, PD is very much in the foreground in service-oriented and component-based development of systems. One application case is that of building or expanding component libraries that are further applicable. A component VD, PD can be either a blend of other components/services or else a component nucleus that consists of control logic and mechatronics. For such a component nucleus, the engineering environment EU allows for the development of the physical behavior (kinematics) of the geometry (3D model), service functions, service interfaces, and actuator/sensor link. For the development of service logic and the link to an IO, it holds true that the service logic must function in the real and virtual environments. This means that the logic which is necessary for IO activity and emulation of physical behavior, to be strictly separated from the service implementation, is to be linked through an interface for real and virtual services.

Furthermore, the engineering platform EU offers the capability of connecting the virtual communication platform KP through a host-Ethernet interface NI to the production-system network, so that transparent data exchange is possible between the engineering system and real components PD1 . . . PDN, as well as between virtual and real components.

FIG. 4 shows the structure of a simulation and analysis for virtual components VD1 . . . VDN. In this case, the virtual components VDX and their practical interplay are separated completely from the outside world in the tested virtual environment EU. The progress of the application and the status of the components is visualized and analyzed in the engineering tool. The virtual components VD1, VD2 can also run on physically separate computers.

FIG. 5 shows the structure of a run-time diagnostic. In the engineering environment EU, the reality is depicted as a model, either 1:1 or only in part, limited to a subset. This means that for each real component PD1 . . . PDN, for which diagnostic information will be depicted, a counterpart must be available as a virtual component VD1 . . . VDN. The application now runs on real components, which transmit status information/commands to the engineering environment through a diagnostic service interface. There, the information is processed and is suitably depicted in the model (motion, alarm, reports).

FIG. 6 shows a test-and-supervision structure. In this case, the control of the virtual components VD1 . . . VDN is seen. But now the difference therein consists of transmitting the service request not (just) to a virtual component VD2, but also to the corresponding real component PD2, which executes the service operation, and of synchronizing the relevant virtual component through the diagnostic interface.

1. A automation system (AS) with decentralized, distributed components and/or devices (PD1 . . . PDN) in a flexible and reconfigurable production environment, with at least one host computer (HR), which is connected through a network (KM) such as Ethernet to the decentralized, distributed components and/or devices (PD1 . . . PDN), in which a simulation-based engineering environment (EU) is implemented in the at least one host computer (HR),
characterized by the fact
that the real components (PD1 . . . PDN) as well as the virtual components (VD1 . . . VDN) of the real components consist of a mechatronic module (MM), a control module (SM), and a communication module (WS), that the mechatronic module (MM) images visible and physical properties of machine and electronic parts, that the control module (SM) images the control logic of the components, and that the communication module (WS) is achieved in the form of a web service, that the virtual models (VD1 . . . VDN) of the components and the real components (PD1 . . . PDN) are constructed as service-oriented, in which component functionalities of both the virtual models (VD1 . . . VDN) of the components and of the real components (PD1 . . . PDN) are available as services (WS) for other virtual and/or real components of the automation system on the basis of web-service technology, that the communication platform (KP) is constructed as service-oriented, they are exchangeable through the services based on web-service technology between implemented virtual models (VD1 . . . VDN) of components and/or the real components (PD1 . . . PDN), in which the virtual models of the components and the real components exhibit the same communication platform (KP) in the form of a protocol stack, and that the service-oriented communication platform is coupled through an interface to the network of the automation system.

2. An automation system according to claim 1, characterized by the fact that the implemented virtual models of components (VD1 . . . VDN) in the host computer (HR) are addressable and autonomous as virtual service entities (SI) in the virtual net.

3. An automation system according to claim 1, characterized by the fact that the virtual service entities (SI) are discoverable and addressable outside the virtual net, in particular by assigning a physical endpoint address.

4. An automation system according to claim 1, characterized by the fact that the virtual service-oriented communication platform (KP) is achievable through the standard network and process functions of the operating system of the host computer (HR).

5. An automation system according to claim 1, characterized by the fact that the components (VD1, VD2) are implemented as service-oriented components (VD1, VD2) on the same host computer (HR) in separate processes or threads and are available through their own endpoint addresses.

6. An automation system according to claim 1, characterized by the fact that communication between host-internal services (VWS) as well as between host-internal services (VWS) and external services (WS) of a component is feasible, transparently discoverable and addressable on the net.

7. An automation system according to claim 1, characterized by the fact that service-oriented systems of components are exportable to the virtual simulation-based engineering platform (EU).

8. An engineering system (EN) for the integrated support of the life cycle of decentralized, distributed components and/or devices (PD) in flexible and reconfigurable production environments with the aid of integrated, simulation-based engineering,
characterized by the fact
that the real components (PD1 . . . PDN) as well as the virtual components (VD1 . . . VDN) of the real components consist of a mechatronic module (MM), a control module (SM), and a communication module (WS), that the mechatronic module (MM) images visible and physical properties of machine and electronic parts, that the control module (SM) images the control logic of the components, and that the communication module (WS) is achieved in the form of a web service, that the virtual models (VD1 . . . VDN) of the components and the real components (PD1 . . . PDN) are constructed as service-oriented, in which component functionalities of both the virtual models (VD1 . . . VDN) of the components and of the real components (PD1 . . . PDN) are available as services (WS) for other virtual and/or real components of the automation system on the basis of web-service technology, that the communication platform (KP) is constructed as service-oriented, they are exchangeable through the services based on web-service technology between implemented virtual models (VD1 . . . VDN) of components and/or the real components (PD1 . . . PDN), in which the virtual models of the components and the real components exhibit the same communication platform (KP) in the form of a protocol stack, and that the service-oriented communication platform is coupled through an interface to the network of the automation system.
